(19) United States
(12) Patent Application Publication
(10) Pub. No.: US 2010/0071436 A1
(43) Pub. Date: Mar. 25, 2010

(54) Data Comm Installer Tool

(76) Inventors: Patrick J. Radle, Mequon, WI (US); David L. Wiesemann, Pewaukee, WI (US); Anthony W. Gilbert, Waukesha, WI (US)

Correspondence Address: QUARLES & BRADY LLP, 411 E. WISCONSIN AVENUE, SUITE 2040, MILWAUKEE, WI, 53202-4497, US

(21) Appl. No.: 12/562,287

(22) Filed: Sep. 18, 2009

Related U.S. Application Data
(60) Provisional application No. 61/098,567, filed on Sep. 19, 2008.

(51) Int. Cl. H01R 43/042

(52) U.S. Cl. 72/409.14; 29/751; 29/705

(57) ABSTRACT

A cable terminal installer tool comprises a data comm jack terminal crimper having a pair of handles at one end and a crimper head at another end for installing data comm jack terminals on the ends of cables. The crimper head is operated by the handles to crimp the terminals onto wire ends of a cable. The tool further comprises a line tester including a transmitter and a receiver for testing an assembled data comm cable having jack terminals at opposite ends. At least one of the transmitter and receiver is detachable from the handles.

CROSS-REFERENCE TO RELATED APPLICATION

This application claims the benefit of U.S. Provisional Patent Application No. 61/098,567 filed Sep. 19, 2008, the disclosure of which is hereby incorporated by reference in its entirety.

### STATEMENT CONCERNING FEDERALLY SPONSORED RESEARCH OR DEVELOPMENT

Not applicable.

### FIELD OF THE INVENTION

This invention relates to data comm installer tools, and in particular to a crimper tester tool for crimping data comm connectors such as phone jacks and network connectors to cables and testing the integrity of the completed cable.

### BACKGROUND OF THE INVENTION

Crimping tools are commonplace and are used by data comm installers and do-it-yourselfers to attach data comm connectors, such as phone jack connectors (e.g., RJ11 connectors) and network connectors (e.g., Cat-5 8P8C or RJ45 connectors) to cables. However, installing such connectors to cables is not an exact science since the wire ends of the cable are very small. Sometimes the crimp quality of the wires to the connectors is poor, so it is a good practice to check the performance of the connection once it is completed. The connector at one end of the cable is plugged into a transmitter and the connector at the other end of the cable is plugged into a receiver. The transmitter generates signals that are communicated to the receiver by the connectors and the cable and the receiver gives an indication as to whether there are any faults in the assembled cable.

This process has required two separate tools for crimping and testing cables and the tester comprises two pieces. As such, there are three separate items for the installer to carry around and keep track of. Accordingly, an improved tool for data comm installation is needed.

### SUMMARY OF THE INVENTION

According to one aspect, the present invention provides a cable terminal installer tool that comprises a data comm jack terminal crimper having a pair of handles at one end and a crimper head at another end for installing data comm jack terminals on the ends of cables. The crimper head is operated by the handles to crimp the terminals onto wire ends of a cable. The tool further comprises a line tester including a transmitter and a receiver for testing an assembled data comm cable having jack terminals at opposite ends. At least one of the transmitter and receiver is detachable from the handles.

In another aspect, the cable connector installation tool comprises a first handle and a second handle pivotally connected to the first handle. The tool further comprises a crimper head defined by the first and second handles. The head includes a first crimping station for crimping a network jack on to a network cable as the second handle pivots relative to the first handle and a second crimping station for crimping a phone jack on to a phone cable as the second handle pivots relative to the first handle. The tool further includes a transmitter supported by the first handle. The transmitter includes a connector receptacle for connecting to a first end of a cable and sends a test signal through the cable. The tool further includes a receiver supported by the second handle. The receiver includes a connector receptacle for connecting to a second end of the cable and receives the test signal through the cable to evaluate the cable for data transmission and electrical continuity.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a left side elevation view of a tool incorporating the invention, with the handles open;

FIG. 2 is a view like FIG. 1 with the handles closed;

FIG. 3 is a view like FIG. 2 with a releasable transmitter removed from the handle of the tool;

FIG. 4 is a rear elevation view of the tool illustrating transmitter and receiver connector receptacles;

FIG. 5 is a section view of part of the handle and the transmitter;

FIG. 6 is a section view like FIG. 5 with the transmitter removed from the handle;

FIG. 7 is a perspective view of the transmitter illustrating an interface for connecting to the handle;

FIG. 8 is a perspective view of the interface between the transmitter and the handle;

FIG. 9 is a view like FIG. 2 and including short cables to make a kit;

FIG. 10 is a view of the components of FIG. 9 in a tool pouch;

FIG. 11 is an electrical schematic of a receiver of the tool; and

FIG. 12 is an electrical schematic of the transmitter.

### DETAILED DESCRIPTION OF THE PREFERRED EMBODIMENT

Referring to FIG. 1, a data comm installer tool 10 includes a data comm connector crimper having a pair of handles 12 and 14 and a crimper head 16 at the opposite end from the handles 12 and 14. The head 16 is operated by the handles to crimp data comm connectors, such as telephone jacks (e.g., RJ11 connectors) or network jacks (e.g., Cat-5, Cat-5E, Cat-6, and Cat-3 8P8C or RJ45 connectors), onto the wire ends of a cable. The head 16 includes a first station 18 for crimping phone jacks onto wire ends, a second station 20 for crimping network jacks onto wire ends, and a guillotine-type cut-off station 22.

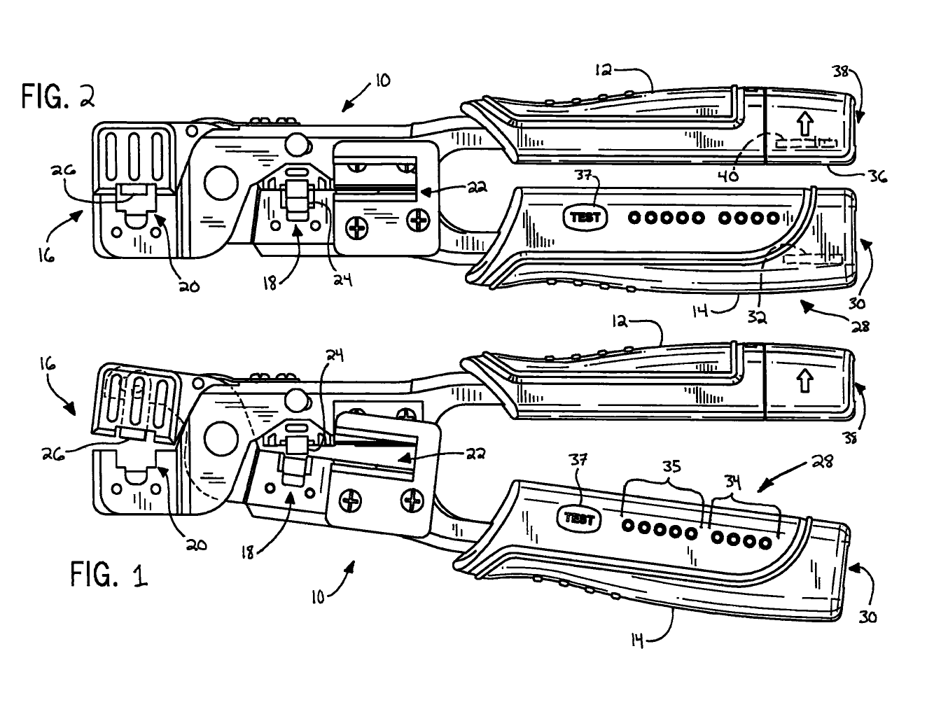

FIG. 2 illustrates the tool 10 with the handles 12 and 14 closed. In this position, the cut-off blades at station 22 have been brought together to cut off a wire placed between them and crimping blades 24 and 26 have moved into their respective crimping stations 18 and 20 so that they would push the contact terminals of a modular connector placed in the respective station 18 or 20 into contact with the wire ends placed in the connector. There are many different types of phone and network crimpers available that could be used to practice the present invention.

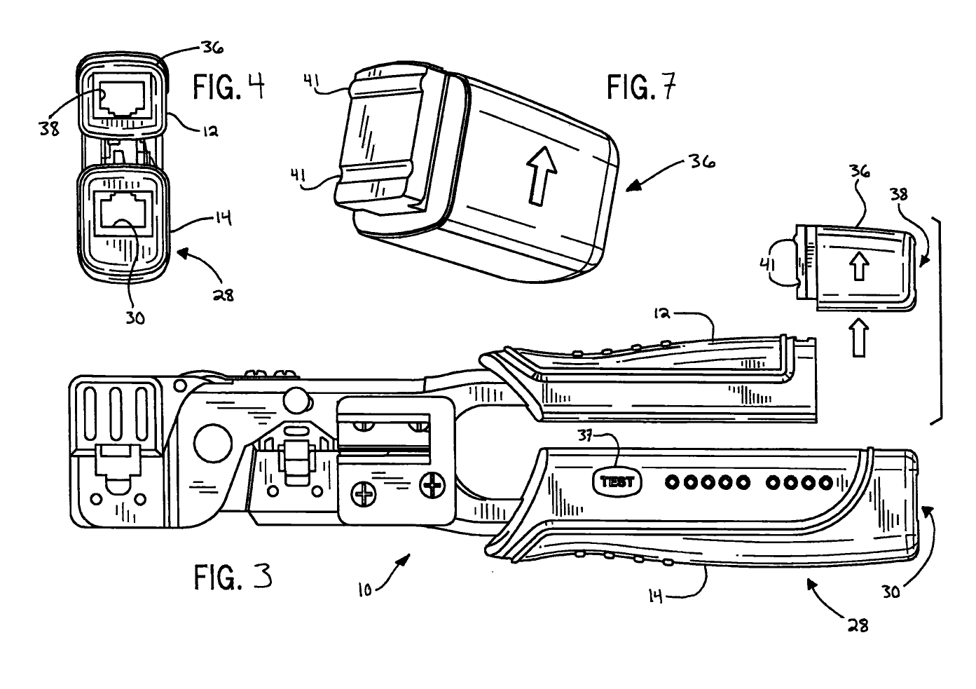

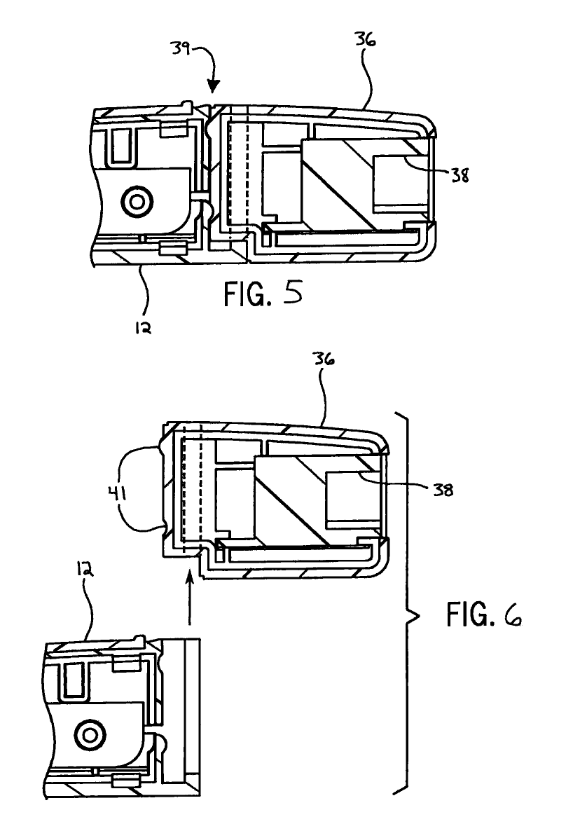

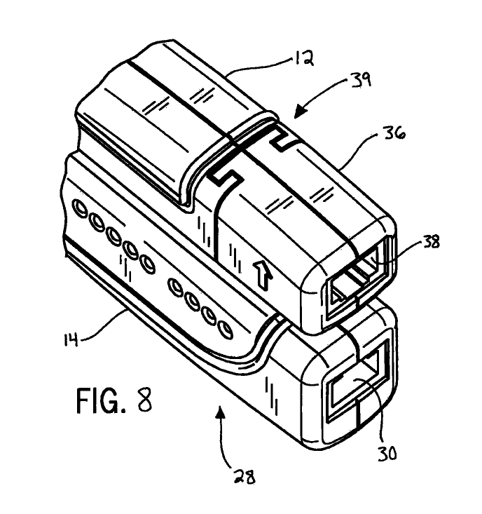

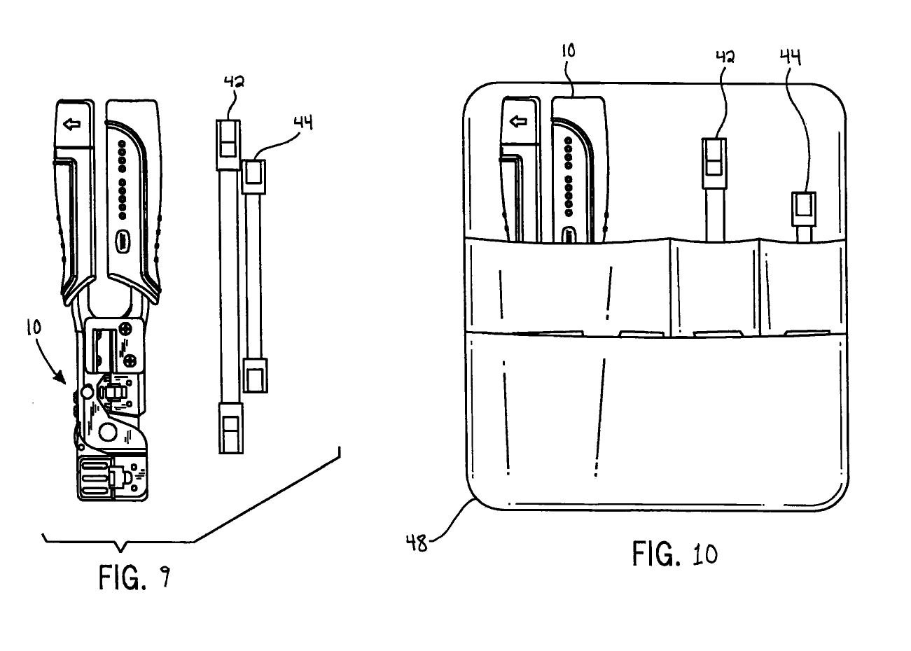

Referring now to FIGS. 1-8, the handles 12 and 14 include a line tester for testing assembled data comm cables. The tester includes a receiver 28, provided in the lower handle 14, and a transmitter 36 detachably connected to the upper handle 12. The receiver 18 includes a receptacle 30 that accommodates both phone and network jacks. The receiver 28 also includes a circuit board 32 inside the handle 14 and indicators 34 (e.g., LEDs) to indicate if a bad connection, such as a short, a miswire, a reversal, or a split pair, is made. Another set of indicators 35 (e.g., LEDs) correspond to wire pairs (e.g., 1-2, 3-6, 4-5, and 7-8) and the cable shield. A test button 37 is provided on handle 14 to turn the power on and off so that a cable can be connected to the handle 14 and then the other end of the cable connected to the transmitter 36 and tested therewith.

The transmitter 36 includes a circuit board 40 and a receptacle 38 that accommodates both phone and network jacks. The transmitter 36 is received in the handle 12 with a dovetail-like interface 39 so the transmitter 36 can be slid into the handle 12 and retained therein, or removed from the handle 12 to test a connection. Friction or one or more protruding or recessed detents 41 can be provided to hold the transmitter 36 in the handle 12 until it is desired to be removed.

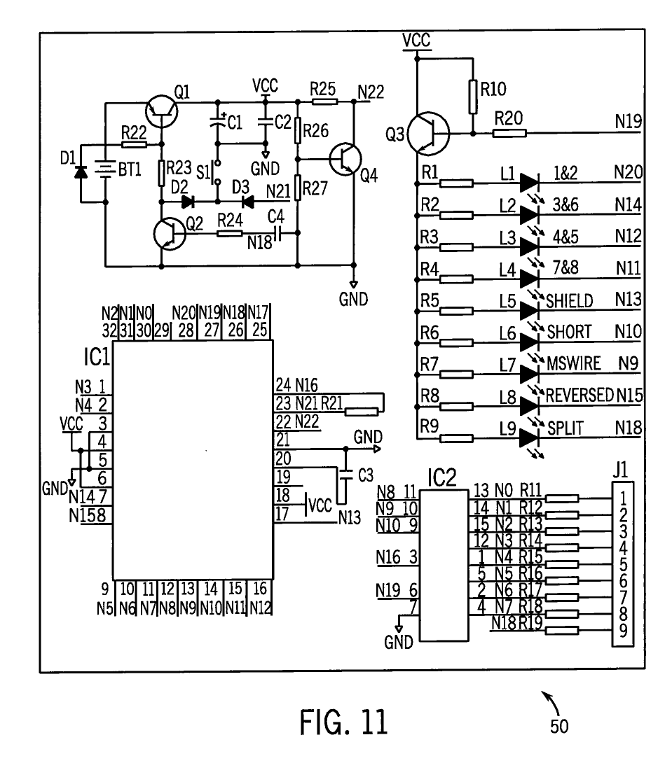

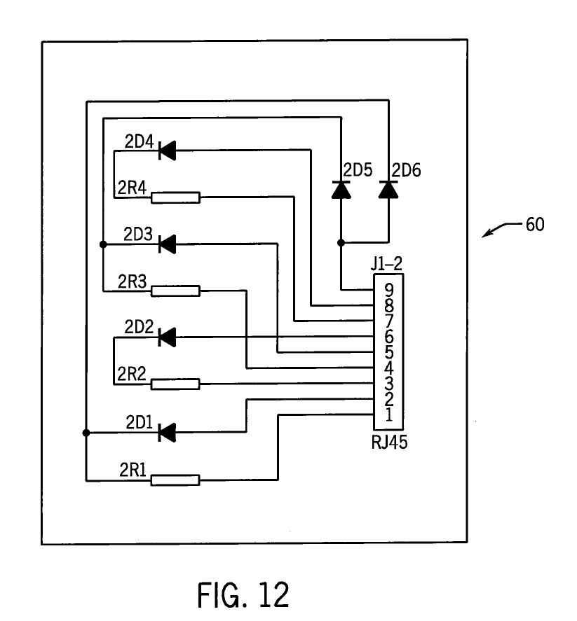

The transmitter and receiver circuitry can be any of several different commercially available designs, such as those represented by the receiver schematic 50 of FIG. 11 and the transmitter schematic 60 of FIG. 12. In any case, the transmitter and receiver circuitry preferably permits the tool 10 to operate as follows. After connecting a terminated cable to the receptacles 30 and 38, a user presses the test button 37. The transmitter 36 then transmits a signal to the receiver 28 such that the cable is tested for both electrical continuity and proper transmission of data signals. If the cable is wired correctly, the indicators 35 corresponding to the wire pairs each provide an indication (e.g., each of the LEDs corresponding to the 1-2, 3-6, 4-5, and 7-8 wire pairs glow green). If the shield on the cable is correctly and continuously wired through the plug termination, the indicator 35 corresponding to the shield provides an indication (e.g., the LED corresponding to the shield glows green). If the cable has a fault as described above (i.e., a short, a miswire, a reversal, or a split pair), the appropriate fault indicator 34 provides an indication and the corresponding wire pair indicator 35 provides an indication (e.g., the LED corresponding to a short flashes red and the LED corresponding to the 1-2 wire pair flashes green to indicate a short between the 1-2 wire pair). Furthermore, the circuitry provides a debug mode that identifies which wire pairs have wiring faults. In the debug mode, the tool 10 cycles through the wire pairs and displays the test results. For example, a short flash of an indicator 35 corresponding to one of the wire pairs indicates that the pair is being tested. A long flash of an indicator 35 corresponding to one of the wire pairs indicates the destination of the test.

Referring to FIGS. 9 and 10, a useful kit includes a tool 10, one or more short network jumper cables 42 for testing female network receptacles and one or more short phone jack cables 44 for testing phone jack female receptacles. As such, the transmitter 36 may be disconnected from the handle 12 and the short cables 42 or 44 may be used to test female-to-female cables (i.e., cables within walls and terminated at wall jacks) between different rooms. The kit also includes a pouch 48 for storing and carrying around the tool and the jumper cables 42 and 44. The pouch 48 may also include a space for carrying loose items such as cable connectors.

A preferred embodiment of the invention has been described in considerable detail. Many modifications and variations to the preferred embodiment described will be apparent to a person of ordinary skill in the art. Therefore, the invention should not be limited to the embodiment described.

We claim:

1. A cable terminal installer tool comprising a data comm jack terminal crimper having a pair of handles at one end and a crimper head at another end for installing data comm jack terminals on the ends of cables, the crimper head being operated by the handles to crimp the terminals onto wire ends of a cable, and a line tester including a transmitter and a receiver for testing an assembled data comm cable having jack terminals at opposite ends wherein at least one of said transmitter and receiver is detachable from said handles.

2. The installer tool of claim 1, wherein the transmitter is detachable from one of the handles.

3. The installer tool of claim 1, wherein the receiver is built into and is not detachable from one of the handles.

4. The installer tool of claim 3, wherein the transmitter is detachable from the other of the handles.

5. The installer tool of claim 1, wherein the installer tool is capable of crimping both telephone jack terminals and Cat-5 terminals onto the ends of cables.

6. A cable connector installation tool, comprising:
a first handle;
a second handle pivotally connected to the first handle;
a crimper head defined by the first and second handles, the head including:
a first crimping station for crimping a network jack on to a network cable as the second handle pivots relative to the first handle;
a second crimping station for crimping a phone jack on to a phone cable as the second handle pivots relative to the first handle;
a transmitter supported by the first handle, the transmitter including a connector receptacle for connecting to a first end of a cable and the transmitter sending a test signal through the cable; and
a receiver supported by the second handle, the receiver including a connector receptacle for connecting to a second end of the cable and the receiver receiving the test signal through the cable to evaluate the cable for data transmission and electrical continuity.

7. The cable connector installation tool of claim 6, wherein the crimper head further includes a cut-off station for cutting a cable as the second handle pivots relative to the first handle.

8. The cable connector installation tool of claim 6, wherein the transmitter is removably supported by the first handle.

9. The cable connector installation tool of claim 6, wherein the receiver is supported within the second handle.
